(19) United States
(12) Patent Application Publication
(10) Pub. No.: US 2017/0344876 A1
(43) Pub. Date: Nov. 30, 2017

(54) EFFICIENT SPARSE PARALLEL WINOGRAD-BASED CONVOLUTION SCHEME

(71) Applicant: Samsung Electronics Co., Ltd., Suwon-si (KR)

(72) Inventor: John W. BROTHERS, Calistoga, CA (US)

(21) Appl. No.: 15/593,210

(22) Filed: May 11, 2017

Related U.S. Application Data
(60) Provisional application No. 62/343,721, filed on May 31, 2016.

(51) Int. Cl. G06N 3/04; G06F 17/15

(52) U.S. Cl. CPC G06N 3/04; G06F 17/153

(57) ABSTRACT

A system and a corresponding method are configured to generate a plurality of output feature maps from an input feature map. The system includes a first input data path (IDP), a request assembly unit (RAU), and a multiply accumulate array (MAA). The IDP transforms a first input feature map to a Winograd domain and generates a first plurality of requests in which each request is for a first plurality of non-zero weights of transformed weight kernels with corresponding elements. The RAU receives the first plurality of requests. The MAA generates a plurality of output matrices in parallel for a first output feature map based on applying the first plurality of non-zero weights to corresponding elements for each input matrix.

### CROSS-REFERENCE TO RELATED APPLICATION

This patent application claims the priority benefit under 35 U.S.C. §119(e) of U.S. Provisional Patent Application No. 62/343,721, filed on May 31, 2016, the disclosure of which is incorporated herein by reference in its entirety.

### TECHNICAL FIELD

The subject matter disclosed herein generally relates to convolutional neural networks (CNNs), and more particularly, to an apparatus and method that efficiently skips 0-value weights in parallel in a Winograd-based implementation of convolutions.

### BACKGROUND

Convolution operations account for about 90% of the computation that is required to execute a CNN, both for inference and for backpropagation done during network training. A Winograd-based convolution method significantly reduces the number of multiply operations required to execute the convolution operations in a CNN. Depending on the filter kernel size and the size of the output matrix generated by a Winograd transformation, the reduction may be between 2 times to 4 times the number of multiply operations, and in some cases there may be an even greater reduction. The reduction in multiply operations, however, comes at the cost of some overhead in transforming the input data (read from the input feature maps) into a Winograd domain in which some add operations are required. Additionally, weight kernels must be transformed into the Winograd domain, but this can typically be done once offline. After doing an element-wise multiply of the transformed data and transformed weight kernel matrix, a final transform is needed, but this can be done after summing results from all convolved input feature maps. Accordingly, the final transform operation may be amortized so that the overhead amounts to very small portion of the overall operations.

As with standard convolution kernels, a large percentage of the weights in a Winograd-transformed weight matrix may be pruned (i.e., set to 0). For example, 50% of the weights might be set equal to 0 in which case the weight kernel matrix elements remaining after pruning may be retrained to maintain the accuracy of the overall neural network.

Currently, the best implementations of convolution-layer processing are done by graphic processing units (GPUs). It may be difficult, however, for GPUs to efficiently implement parallel 0-value weight skipping. GPUs also do not include pruning of the Winograd-transformed weights, so there may be relatively little sparsity in the weight kernel matrices in order to take advantage of skipping any 0-value weights.

### SUMMARY

One example embodiment provides a method that may include transforming, by a first input data path (IDP) unit, a first input feature map to a Winograd domain, wherein the transformed first input feature map may include a first plurality of input patches, and wherein each input patch of the first plurality of input patches may include a plurality of elements; providing, by the first IDP unit, a first plurality of requests, each for a first plurality of non-zero weights of transformed weight kernels with corresponding elements to a request assembly unit (RAU); and generating, by a first multiply accumulate array (MAA), a plurality of output matrices in parallel for a first output feature map based on applying the first plurality of non-zero weights to corresponding elements for each input matrix. In one embodiment, the method may further include determining, by a position determiner within the first IDP unit a position of at least one non-zero-value weight within the first transformed weight kernel; and wherein providing, by the first IDP unit, the first plurality of requests may further include providing, by the first IDP unit, the first plurality of requests, each for the first plurality of non-zero weights of transformed weight kernels with corresponding elements to the RAU and skipping a request corresponding to the position of the at least one zero-value weight within the first transformed weight kernel.

One example embodiment provides a system to generate a plurality of output feature maps from an input feature map in which the system may include an IDP, an RAU and a MAA. The IDP may transform a first input feature map to a Winograd domain in which the transformed first input feature map may include a first plurality of input matrices, and each input matrix of the first plurality of input matrices may include a plurality of elements, in which the first IDP may further generate a first plurality of requests, each for a first plurality of non-zero weights of transformed weight kernels with corresponding elements. The RAU may be coupled to the first IDP to receive the first plurality of requests. The MAA may be coupled to the RAU to generate a plurality of output matrices in parallel for a first output feature map based on applying the first plurality of non-zero weights to corresponding elements for each input matrix. In one embodiment, the system may further include a position determiner to determine a position of at least one zero-value weight within the first transformed weight kernel, wherein the first IDP unit may further provide the first plurality of requests, each for the first plurality of non-zero weights of transformed weight kernels with corresponding elements to the RAU and to skip a request corresponding to the position of the at least one zero-value weight within the first transformed weight kernel.

### BRIEF DESCRIPTION OF THE DRAWINGS

In the following section, the aspects of the subject matter disclosed herein will be described with reference to exemplary embodiments illustrated in the figures, in which:

FIG. 1 depicts a Winograd transformation as applied to n 8×8 feature maps in which n is an integer that is greater than or equal to 2;

FIG. 2 depicts an example embodiment of a system architecture that efficiently convolves n Winograd-transformed feature-map matrices to form an output map patch according to the subject matter disclosed herein;

FIG. 3 depicts an example embodiment of a request-assembly unit within an example embodiment of a multiply-accumulate array according to the subject matter disclosed herein;

FIG. 4 depicts additional example details relating to the parallel nature of the system architecture according to the subject matter disclosed herein; and

FIG. 5 depicts an electronic device that includes one or more integrated circuits (chips) forming a system that efficiently skips 0-value weights in parallel in a Winograd-based implementation of convolutions according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail not to obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing particular exemplary embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement the teachings of particular embodiments disclosed herein.

Unless otherwise defined, all terms (including technical and scientific terms) used herein have the same meaning as commonly understood by one of ordinary skill in the art to which this subject matter belongs. For example, the term “mod” as used herein means “modulo.” It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. The term “software,” as applied to any implementation described herein, may be embodied as a software package, code and/or instruction set or instructions. The term “hardware,” as applied to any implementation described herein, may include, for example, singly or in any combination, hardwired circuitry, programmable circuitry, state-machine circuitry, and/or firmware that stores instructions executed by programmable circuitry. The modules may, collectively or individually, be embodied as software, firmware and/or hardware that forms part of a larger system, such as, but not limited to, an integrated circuit (IC), system on-chip (SoC) and so forth.

The subject matter disclosed herein provides a system that efficiently skips 0-value weights in parallel in a Winograd-based implementation of convolutions. In one embodiment, the subject matter disclosed herein relates to a system in which multiple input nodes in multiple input feature maps (IFM) are convolved in parallel, thereby maximizing computational throughput. In one particular embodiment, four or eight input feature maps may be convolved in parallel and from each feature map 4×4 patches of convolved outputs are generated and summed together providing a throughput of 64 or 128 convolved output values per cycle. In other embodiments, the number of input feature maps may be scaled to process any number of input feature maps in parallel and/or larger or smaller patches.

According to one embodiment, multiple input units, in which each input unit corresponds to an input feature map, may convolve the input feature maps with corresponding filter kernels and the results are then summed to generate multiple output feature maps (OFMs). In each of the input feature maps, multiple patches may be transformed into, for example, the Winograd domain. For example, 16 2×2 patches may be transformed into Winograd domain in each input feature map, which might make up an 8×8 region of an input feature map. Each input feature map is then convolved with a different filter kernel. The filter kernel is transformed offline into the Winograd domain and pruned in that domain, so some of the transformed weights may have a 0 value. In each respective filter kernel, the 0-valued weights may be in different positions. Convolutions are done by doing an element-wise multiply of the transformed input patch elements with the transformed weight values. In each input feature map, element-wise multiplies are performed by applying just one transformed weight per cycle to all of the transformed data matrices. By doing one weight at a time, processing of 0-valued weights may be skipped by iterating through the non-0 weights in the transformed filter kernel. Each weight is associated with a 2D position in the element-wise multiply operation.

For example, a weight value at a position (1,3) in a filter kernel may be used to compute an element (1,3) and is applied to the transformed input data element at (1,3). If there are 16 patches, the weight is applied to the data elements in the (1,3) position of all 16 patches in the same cycle and added to 16 accumulators corresponding to the (1,3) position. Since there are multiple input feature maps processed in parallel, each with a different kernel, this process may be replicated, for example, eight times so that in one cycle, one non-zero transformed weight is applied to the corresponding element of the corresponding input feature map. One input-feature-map filter kernel might have, for example, a non-0 weight to process at position (1,3), whereas another input-feature-map filter kernel might have a non-0 weight at position (2,2). In the same cycle, requests may be issued to apply the non-0 weights at the two different positions. The other six input feature maps units will try to apply non-0 weights at other positions because, in general, they may have 0s in different 2D positions in their respective weight kernels.

All contributions from all input feature maps for a given output element (for example, at a position (1,3)) may be processed in the same cycle by the input units. The input units apply eight weights to eight inputs (each from a different input feature map), sum the results, and add the results to a corresponding accumulator—the one corresponding to position (1,3) in this case. Since the contributions are to update the same output element, the weight position processed for all 8 input feature maps are the same—position (1,3) in this case.

Since the weights are processed for the same position within the filter kernel and the input units are making requests to apply weights for different positions, a request-assembly unit may coalesce and reorder—the different requests across multiple cycles into larger requests that process weights only for a single position in each cycle. In a first cycle, one input unit may request processing of a weight at a position (1,3), and a second input unit may request processing of a weight at a position (0,1). In a second cycle, the first input unit may request processing of a weight at position (0,1), and the second input unit may request processing of a weight at position (1,3). In response, a request-assembly unit may reorder the input requests so that in one cycle, the weights at position (1,3) are processed and at a subsequent cycle, the weights at position (0,1) are processed. Multiple output feature maps may be generated from the multiple input feature maps by processing the input feature maps in parallel.

According to another embodiment, multiple input feature maps are convolved in parallel and summed together to generate one output feature map. Each input feature map and a corresponding transformed weight matrix are processed by an IDP unit. In a system configuration that convolves eight input feature maps in parallel, there will be eight IDP units in which each IDP unit processes one of the eight input feature maps and the corresponding kernel weights. Each IDP unit does a transformation of 16 patches of the one input feature map into, for example, the Winograd domain. For example, an input patch includes Winograd-transformed data needed to generate a 2×2 matrix of final output data. In the case of applying a 3×3 kernel to generate 2×2 output patches, the input data may be converted to 4×4 Winograd-transformed inputs. The IDP unit transforms 16 input patches per input map to generate 16 sets of 4×4 transformed input patches for the input feature map. The IDP unit also selects the next non-zero weight in the corresponding Winograd-transformed weight kernel, which is also a 4×4 matrix. The weight has a corresponding xy position that determines which element in each of the 16 transformed input patches is to be multiplied by the selected weight. For example, if the current weight is at a position (1,3) in the kernel, the (1,3) elements of the 16 transformed input patches are selected. The weight and the 16 input values are then processed by a request-assembly unit. The seven other IDP units process in parallel other corresponding input maps and corresponding weight kernels in the same way. Each IDP unit sends the resulting weight and 16 input values in a request for processing to the request-assembly unit.

Since each weight kernel for the eight different input feature maps have 0 values at different positions, each of the requests may correspond to different xy positions. For example, a first IDP unit might generate a request to process a weight at a position (1,3), whereas a second IDP unit might request to process a weight at a position (0,0), and so on. An array of 16 multiply-accumulate units (MAU) are coupled to the request-assembly unit to process the requests. Each MAU takes as inputs eight sets of input values and a corresponding set of eight weights. In parallel, each of the eight inputs is multiplied by its corresponding weight to generate eight results. The eight results are all added into 1-of-16 accumulator registers maintained by the IDP unit, each corresponding to one of the 16 elements of the output patch being computed by the MAU. Each of the 16 MAUs compute a different one of the 16 output patches being computed in parallel. The inputs that are coupled into one MAU all correspond to the same output value being computed in a given cycle. For example, each of the eight inputs and their corresponding weights coming from eight different input feature maps might be for element in position (1,3) in a given cycle. Each IDP unit generates processing requests for different input feature maps and, since the corresponding weight kernels have 0 weights at different positions in the kernels, the requests generated by the input fetch units may be for processing of different output elements. The purpose of the request-assembly unit is to receive requests made over multiple cycles, and reorder the requests so that the request-assembly unit generates one request to the MAU where in the inputs and weights from each of the eight input feature maps correspond to the same xy position in an output matrix. For example, a request is to update, for example, the output element at position (1,3), in which case the eight weights are from the elements at position (1,3) of the respective weight matrices and the input data elements at position (1,3). By reassembling the requests in this way, all eight MAU multipliers and the adders below the MAU multipliers may perform computations in parallel and be fully used. If the requests are not reordered, processing of multiple input feature maps in parallel, while skipping zero-value weights, would not be practical.

For the embodiment described, 16 output patches are processed in parallel to generate a portion of one output feature map. It is also possible to process multiple output feature maps in parallel. For example, 16 patches for each of 16 output feature maps may be generated in parallel. In this case, each IDP unit reads and transforms a single input feature map, but 16 different transformed weight kernels are applied to each input map, one kernel per output feature map. The IDP unit transforms the 16 patches of input data into, for example, the Winograd domain. The IDP unit then selects a next non-zero weight from each of the 16 kernels—all of which will correspond to different xy positions in the 4×4 kernels. The IDP unit then sends 16 requests to 16 different request-assembly units, each corresponding to a different output feature map. Each request assembly unit feeds a different set of 16 MAUs,. Each of the 16 request-assembly units and corresponding 16 MAUs act independently of the others, each generating 16 patches of one output map.

Over multiple cycles, all of the 16 elements of each output 4×4 matrix are computed. When all weights have been applied to all input samples for all input maps contributing to the output maps, the resulting 16 accumulated values for each output matrix are fed to a final processing unit, such as a data-return unit (DRU). There may be 16 output matrices per output map processed in parallel, each matrix corresponding to an output patch of the output map and each matrix includes 16 elements. Among other calculations, the DRU may compute a final transformation of the output elements from, for example, the Winograd domain to a linear space. In the final transformation, a 4×4 matrix may be converted to a 2×2 patch, each element of which corresponds to an element of an output map.

Unlike, computation of conventional convolutions, in the Winograd method, the same weight may not be applied to adjacent input samples. Instead, in the Winograd convolution method, an element-wise multiply of transformed weight matrix is done with a matrix of transformed input elements to compute an output matrix. The output matrix is the Winograd transformed representation of an output patch. In the case of a 2×2 output patch, input map data, output map data, and the 3×3 weight kernel are all 4×4 matrices in the Winograd domain.

In one embodiment, the xy dimension is parallelized to enable skipping of 0-value weights, and 16 4×4 matrices may be processed in parallel. In each cycle, one transformed weight may be applied to one transformed data sample from each of the 16 patches. For example, when applying a 3×3 kernel to generate a 2×2 output patch, the input data are transformed to 4×4 matrices and pruned Winograd weight kernels are 4×4 matrices. Sixteen matrices corresponding to 16 output patches are processed in parallel. The same transformed weight matrix is applied to 16 different transformed input matrices. Each cycle, one non-zero weight is chosen from the 4×4 weight matrix and that weight is applied to the 16 corresponding elements, one element from each of the transformed input matrices. Only non-zero weights are applied. Zero-valued weights have no effect and are skipped, saving processing cycles and power. Without skipping 0-value weights, 16 element-wise multiplies are required to compute each 4×4 output matrix. If only four of the 16 weights are non-zero, by skipping processing of 0-value weights, only four multiplies are required to compute the output matrix. By processing in parallel the same non-zero weight value for each of 16 output matrices, just four cycles are required to process all 16 matrices. In this example, there is a factor of four increase in speed by skipping 0-valued weights. Since each output matrix represents a 2×2 patch in the output map—four elements—and it takes four multiply operations to apply the convolution with the Winograd scheme while skipping 0-valued weights, the overall computation per output element is just one multiply.

In contrast, to apply a 3×3 kernel with the conventional convolution implementation, nine multiply operations are required per output without skipping 0-valued weights, and an average of 4.5 multiply operations are needed in the conventional implementation where half of the weights are zeros and can be skipped. Note that a typical percentage of zero-value weights after network pruning for conventional kernels is about 50%. For Winograd kernels used to apply a 3×3 kernel to generate 2×2 patches, the percentage of non-zero weights is closer to 25%.

The dimensions of the transformed input data and transformed weight matrix depend on the output patch size and the kernel size. In one embodiment in which the output patch is always 2×2, applying a 3×3 kernel involves 4×4 transformed weight and data matrices. In a situation in which all of the weights are applied, a 3×3 kernel used to generate a 2×2 output patch would involve 16 multiplies. In another example, where a 5×5 kernel is used to generate a 4×4 patch, the transformed weight and data matrices are 7×7 and 49 multiplies are required to generate a 4×4 output patch if no 0-valued weights are skipped.

The overall throughput may be increased by further parallel processing multiple input maps each cycle. For example, input data to generate 16 output patches of a given output map can be read and transformed from eight different input maps in parallel. A different kernel is applied to each input map to generate that map's contribution to the current output map. The pruned Winograd weight matrix corresponding to each of these different kernels has 0-valued weights at different positions. For example, kernel 1 is applied to input map 1 and kernel 2 is applied to input map 2, and so on. And in the 4×4 weight matrix corresponding to kernel 1, consider a 0-value weight at (0,0). In the second matrix, there is a non-zero value at (0,0). The Winograd scheme does element-wise multiplies of 4×4 matrices and sums the results for all input maps to get a final 4×4 output matrix. For example, for the (0,0) element of the output matrix, only the (0,0) transformed data elements and the (0,0) weight elements are multiplied and summed together. The multiply accumulate hardware units should only sum together elements corresponding to one output matrix element in one cycle. For example, if the MAC unit is processing the (2,2), then all of the input elements and corresponding weights must also correspond to the (2,2) elements of their respective matrices.

Each cycle, an IDP will find the next non-zero weight in the current transformed weight kernel corresponding to the input map it is fetching, transforming, and feeding to its input of each MAU. When eight input maps are processed in parallel, there are eight IDPs, each processing a different input map and weight matrix. Each of the weight matrices has zeros at different positions. So, each cycle, each IDP emits elements (a transformed weight matrix element and input matrix element) corresponding to positions different from the other IDPs—whatever corresponds to the next non-zero weight in the kernel. IDP1 might emit a weight and corresponding input data for (1,1), while IDP2 emits values for (2,2) in that same cycle. Since these correspond to different output elements, they cannot be fed into the same MAU in the same cycle since the MAU multiplies adds the products together into the same accumulator. So, the inputs to the MAUs, generated by the eight IDPs in a given cycle, must be reordered before feeding them into the MAUs. The Request Assembly Unit takes eight requests (the input element and weight elements emitted by each of the eight IDPs), buffers multiple cycles of such requests, and then reorders them to emit reordered requests to the MAUs. The request output by the RAU only has weights and inputs corresponding to a single output matrix position. For example, if the RAU choses to process the (2,2) output element in a given cycle, it selects one (2,2) request buffered from each of the IDPs and emits those together in one cycle. It signals the MAUs to select the accumulator corresponding to the (2,2) output matrix element at the same time. That emitted request is processed in one cycle by each MAU, which multiplies eight weight elements by eight input elements, sums the products together and adds them into the selected accumulator. Note that 16 MAUs will process 16 output patches in parallel, one patch per MAU. All MAUs will process the same position and have the same weight fed in for a given input map. By reordering the scattered requests emitted by the IDPs as they skip over zero weights, the RAU enables parallel processing of multiple input maps, while skipping over 0-value weights in each of the corresponding kernels.

In addition to parallelizing in the XY dimension by processing multiple output patches of the same output map in parallel (for example, 16 patches) and parallelizing in the input channel dimension by having multiple IDPs each operate on different input maps in parallel (for example, eight input maps fed into the each MAU after reordering in the RAU), it is also possible and advantageous to parallelize in the output channel dimension. For example, 16 output maps may be generated in parallel. This is done by replicating logic in the IDPs to process one weight kernel per output map, and by increasing the number RAUs and MAAs proportionally with the number of output channels generated in parallel.

In addition to increase the processing throughput by increasing the number of output channels generated in parallel, overhead involved in transforming input feature map data to the Winograd-domain is also minimized. There is also some overhead in transforming the output matrix back from Winograd to linear domain, but the cost of the output transformation is already very low since it only needs to be done just once after all weighted inputs have been accumulated into a final output matrix. And this is not affected by parallelizing in the output channel dimension. In one embodiment, one output map is processed at a time. In this case, each of the input maps must be read and transformed once from linear to Winograd domain. The final 4×4 output matrix is transformed from Winograd to linear domain once, after summing the weighted contributions from all of the input maps. For example, if there are 64 input maps required to generate an output map, 64 linear-to-Winograd input data transforms are required to generate one output patch. Just one transform is required to convert the 4×4 output matrix from Winograd to linear domain. In another embodiment, 16 output maps are generated in parallel using the same set of input maps, but with different kernels applied to each input map to generate each different output map. The same 64 input maps are each transformed once and the transformed results are each used 16 times to generate output patches for 16 different output maps. In this case, an average of four input map transforms are needed to generate each output map patch. In other words, each input map is transformed once and reused 16 times for 16 different outputs. Over the set of 16 output maps, 64 input map transforms are required: 64/16=4. So, processing multiple output maps in parallel is significantly more efficient in reducing input map reads and transformations of input data.

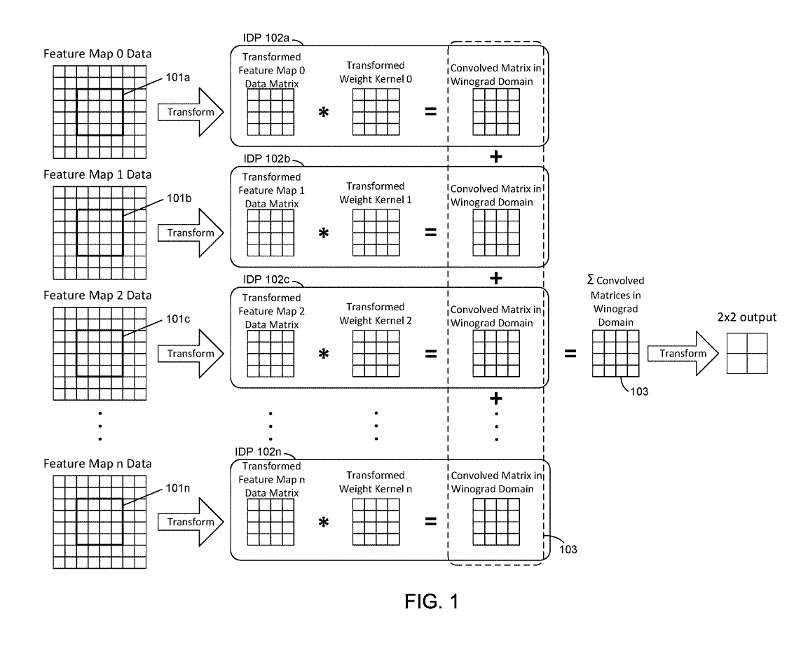

FIG. 1 depicts a Winograd transformation as applied to input data patches in n 8×8 feature maps in which n is an integer that is greater than or equal to 2. In one embodiment, n may be equal to 8. As depicted in FIG. 1, a portion of the data contained in each of n 8×8 feature maps is transformed into the Winograd domain using a 4×4 transform matrix (not shown) to form 4×4 transformed input data patches. That is, a part of each 8×8 feature map (as indicated by the heavy lines at 101a-101n) is transformed into the Winograd domain as a 4×4 transformed feature-map data patch by a transform matrix (not shown), and then a corresponding 4×4 transformed and pruned weight kernel is applied to the transformed input data with an element-wise multiply (up to 16 multiplies) matrix. It should be understood that the transformation matrix that transforms the input data into the Winograd domain is not the transformed weight kernel that is used with the element-wise multiply matrix. Low-valued weights in the transformed weight kernel may be pruned. The transformed weight kernel may contain both non-zero weight values and weight values that are equal to zero. The transformation of the weight kernel into the Winograd domain and pruning may be performed off line. The subject matter disclosed herein includes multiple IDPs 102a-102n in which the respective elements of a transformed feature-map data patch and the weight values in the corresponding transformed weight kernel are multiplied together to form a convolved matrix in the Winograd domain. The elements in the n convolved matrices are respectively summed and the result, indicated at 103, is inverse Winograd transformed to form a 2×2 output feature map patch.

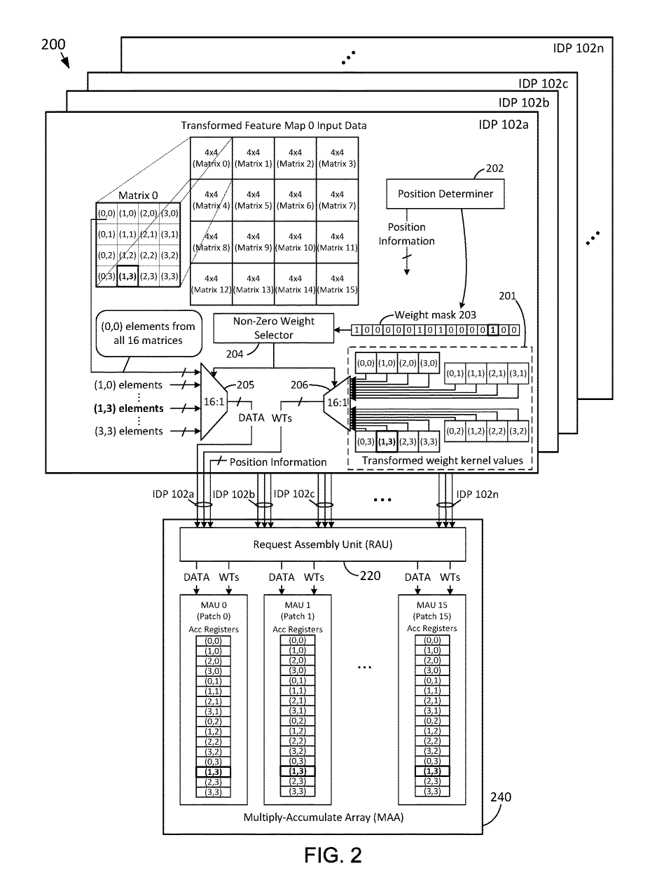

FIG. 2 depicts an example embodiment of a system architecture 200 that efficiently convolves n Winograd-transformed feature-map patches to form an output map matrix according to the subject matter disclosed herein. As depicted in an IDP 102a, an 8×8 feature map 0 has been transformed into the Winograd domain in a well-known manner. The transformed 8×8 feature map 0 is organized into 16 patches (patch 0-patch 15). A 4×4 matrix 0 of transformed input data has been enlarged in FIG. 2 and will be focused on for purposes of explanation. For this example, each position of matrix 0 may contain an 8-bit data value. Weight values in the positions in a transformed weight kernel 201 may be 8-bit weight values.

A position determiner 202 generates a weight mask 203 based on the position of the non-zero weights in the weight kernel. In one embodiment, a position of a 1 in the weight mask 203 is based on a corresponding position of a non-zero weight in the weight kernel. Similarly, a position of a 0 in the weight mask 203 is based on a corresponding position of a weight in the weight kernel that is equal to 0. For purposes of illustration, the position of the 1 in the third position from the right in weight mask 203 (shown in bold) corresponds to the position of the transformed data element in position (1,3) in the weight kernel and the position (1,3) in patch 0.

A non-zero weight selector 204 uses the weight mask 203 to drive two 16:1 multiplexers 205 and 206. The multiplexer 205 selects an element of the transformed input data contained in each of patches 0-15, and multiplexer 206 selects a transformed weight value from the weight kernel. That is, the non-zero weight selector 204 drives the multiplexer 205 to select an element of the transformed input data at a position in each of patches 0-15 that corresponds to a position of each 1 in the weight mask 203. The non-zero weight selector 204 similarly drives multiplexer 206 to select a transformed weight value in the transformed weight kernel 201 at a position in the transformed weight kernel that corresponds to a position of a 1 in the weight mask 203. By way of an example, the 1 (in bold) in weight mask 203 corresponds to the position of the transformed data element at (1,3) in each of patches 0-15 and the transformed weight value at position (1,3) in the weight kernel. In one embodiment, the non-zero weight selector 204 selects transformed data in each of patches 0-15 and in the transformed weight values in the transformed weight kernel 201 only at positions corresponding to positions in the weight mask 203 that contain a 1, and skips positions in the transformed patches 0-15 and the weight kernel that correspond to positions in the weight mask 203 that contain 0, thereby streamlining the convolution of the transformed input data with the corresponding transformed weight values.

The outputs of the multiplexer 205 (transformed data) and the multiplexer 206 (transformed weight value) are input to an RAU 220 in an MAA 240. The request-assembly unit 220 buffers requests from multiple IDP units over multiple cycles and selects requests for the same XY position into a single request. It emits this request which includes the received transformed input data and the corresponding transformed weight value and a position select to select an accumulation register (Acc Register) to the MAA, which includes 16 MAUs. The RAU 220 receives the requests from each of the IDPs 102a-102n, which are all normally applying weights at different positions to different input maps, and reorders the input requests so that in the output request, all of the weights (eight for the eight IDPs 102a-102n in the example embodiment of system architecture 200) apply to the same position (i.e., position (1,3)). Input requests received by the RAU 220 over multiple previous cycles are reordered internally to the RAU 220 in order to coalesce eight requests that are using the same position into one output request. In the output request, the same eight weights are input to all MAUs, except that each MAU receives a transformed input element from a different patch. The particular accumulation register to which the RAU 220 directs the received transformed input data and the corresponding transformed weight value corresponds to the position in the patches from which the transformed input data and the position of the transformed weight value were selected and that also corresponds to the position in the output matrix being processed. For example, using the example of the transformed data element at (1,3) in each of transformed patches 0-15 and the transformed weight value at position (1,3) in the weight kernel 201, the RAU 220 directs the transformed data element at (1,3) in the patch 0 and the transformed weight value at position (1,3) in the weight kernel 201 to the (1,3) register in MAU 0 (for patch 0) where the transformed input data and the transformed weight value are multiplied together and accumulated.

The request-assembly unit 220 similarly directs the transformed data element at (1,3) in the patch 1 and the transformed weight value at position (1,3) in the corresponding weight kernel to the (1,3) register in MAU 1 (for patch 1) where the transformed input data and the transformed weight value are multiplied and accumulated. The process continues for all of the patches, and, in the case for patch 15, the RAU 220 directs the transformed data element at (1,3) in the patch 15 and the transformed weight value at position (1,3) in the corresponding weight kernel to the (1,3) register in MAU 15 (for patch 15) where the transformed input data and the transformed weight value are multiplied and accumulated.

Only the transformed input data at the position in each patch and the transformed weight value at the position in the weight kernel that correspond to a 1 in the weight mask 203 are output to the RAU 220 so that the convolution of the transformed input data with the corresponding transformed weight values is streamlined and operations to multiply by a zero value are eliminated.

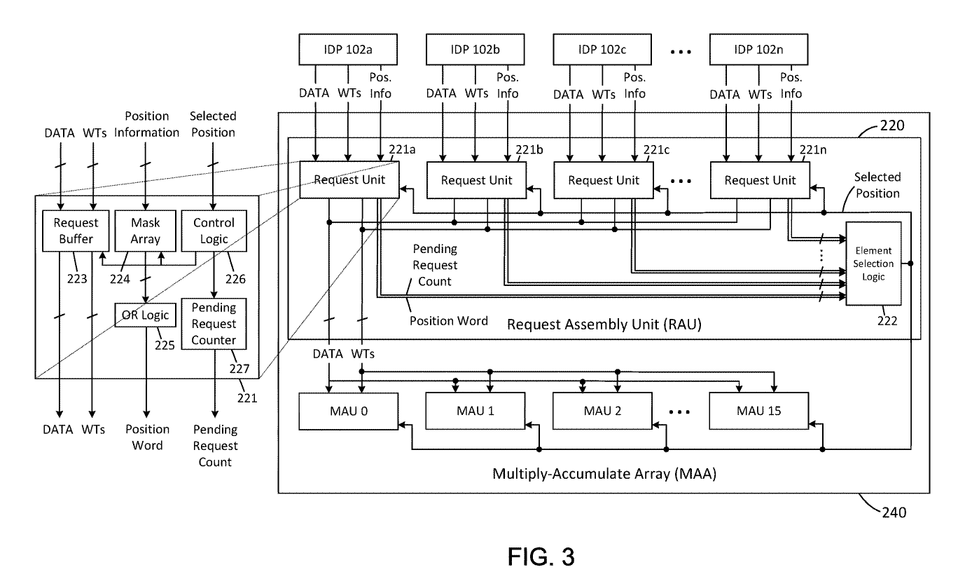

Each IDP 102a-102n outputs transformed input data and corresponding transformed weight values to the RAU 220. The position determiner 202 also outputs to the RAU 220 position information of the non-zero weights in the weight kernel selected by each respective IDP in a given cycle. FIG. 3 depicts an example embodiment of a RAU unit 220 within an example embodiment of a MAA 240 according to the subject matter disclosed herein. The RAU 220 receives the information from each IDP as requests, and reorders the individual requests from the different IDPs 102a-102n, each of which normally corresponds to different positions. For example, one IDP might submit a request to process the (1,3) element, whereas another IDP might request processing of (3,0). In reordering the eight requests arriving in a given cycle and in prior cycles, the RAU 220 emits one coalesced request applying to one position—for example, all will be for position (1,3).

In one embodiment, the RAU 220 includes a plurality of request units 221a-n, and an element-selection logic 222. The request units 221a-221n respectively receive transformed data, transformed weight values and position information from the IDPs 102a-102n. The element-selection logic 222 uses outputs from the respective request units 221 and selects the transformed weight that will be processed in the next cycle. In one embodiment, the RAU 220 receives requests from all n IDPs over the last several cycles in which each request represents an attempt to update a value in a different position, and assembles into one cycle weights and data that will be processed to update one of the output elements.

In one embodiment, a request unit 221 includes a request buffer 223, a mask array 224, a control logic 225, an OR logic 226 and a pending-request counter 227. The request buffer 223 receives the transformed input data and the transformed weight value (requests) from the corresponding IDP 102. In one embodiment, the request buffer 223 may include 16 buffers locations to sequentially receive 16 entries from the corresponding IDP. The mask array 224 receives position information, such as a weight mask 202, from the position determiner 201 and stores the weight mask 202 in an entry corresponding to the transformed input data and transformed weight value received from an IDP 102. In one embodiment, the mask array 224 may include 16 entries. The OR logic 225 logically ORs together the received position information and outputs a position word in which a 1 in a given position in the position word indicates a weight value at the given location. The control logic 226 includes logic to locate and transmit an entry selected by the element-selection logic 222 to the MAUs, logic to update masks in the mask array 224, and logic decrement the pending-request counter 227 in response to a selected entry. The pending-request counter 227 may be incremented for each request received by the request unit 221. The output from the OR logic 225 and the pending-request counter 227 is used by the element-selection logic 222 to select the transformed weight that will be processed in the next cycle.

The element-selection logic 222 sums the number of the request units 221 with pending requests to the same element (x,y position in the weight array) and selects the element with a maximum number of requests. In some instances, all n request units 221 may indicate the occurrence of a weight at a particular position, but in other instances one or more of the request units 221 may have no requests at a particular position, in which case, those request units do not transmit the weights and input data to the corresponding MAU inputs. The fullness of the request buffer 223 may also be factored into the selection process by the element-request unit 222. For example, in circumstances in which a request buffer 223 of a request unit 221 is full, the element-request unit 222 may select an element in the full request buffer 223 of the request unit 221 to relieve the full-queue condition instead prioritizing an element position having an overall maximum number of requests. Full queues may also cause a stall signal (not shown) to propagate to the corresponding IDP.

As described earlier, the system architecture 200 generates a plurality of output feature maps from input feature maps in parallel. For example, 16 output patches are generated from eight input feature maps in parallel. A single MAA unit generates the 16 output patches in one output feature map. According to one embodiment, the system architecture 200 may generate multiple output feature maps from the same input data, so that the output feature maps may be processed in parallel. For example, 16 MAA units generate 16 output feature maps in parallel, and 16 patches are generated within each output feature map in parallel as well. Each IDP 102 reads and transforms 16 patches from one input feature map. Instead of emitting the next non-zero weight from one transformed weight kernel, 16 non-zero weights from 16 different transformed weight kernels are emitted based on one weight and its corresponding position for each of the output feature maps being generated.

For example, in a given cycle IDP 102a emits weight (1,3) from the weight kernel used to generate output feature map 0 and simultaneously emits weight (2,3) from the weight kernel used to generate output feature map 1. All the weights are applied to different elements of the same transformed input data. The different weights and corresponding input data elements are sent to the MAA unit computing the corresponding output feature map. This reduces the overhead of reading and transforming the input data.

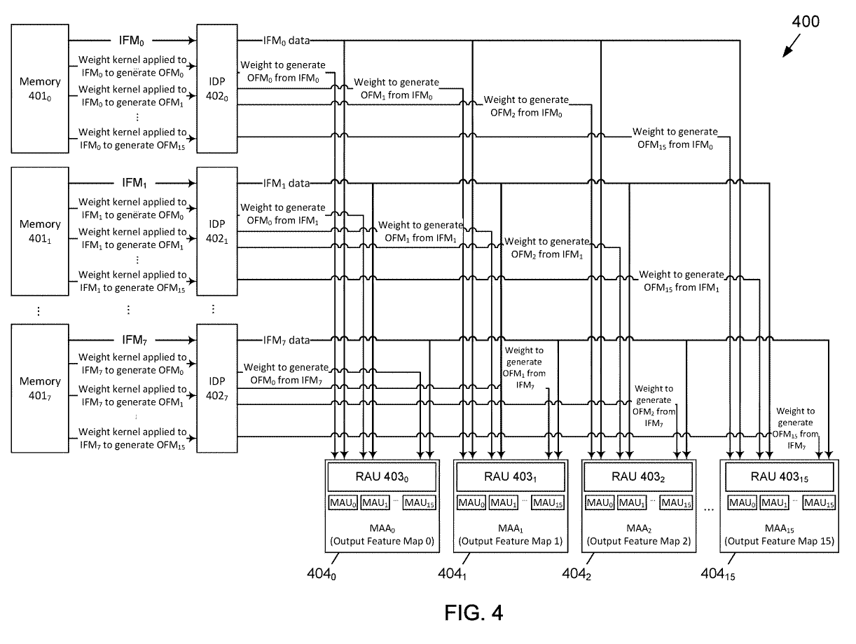

FIG. 4 depicts additional example details relating to the parallel nature of the system architecture 400 according to the subject matter disclosed herein. In particular, FIG. 4 depicts the parallel nature of the system architecture 400 for eight IFMs that are processed to form 16 OFMs. As depicted in FIG. 4, memories 401₀-401₇ may respectively store input-feature maps IFM₀-IFM_{A} for eight IFMs. The memories 401₀-401₇ may also store the weight kernels that will be applied to the IFM that is stored in the memory. The data stored in a memory 401 is processed by a corresponding IDP 402₀-402₁₅ to generate a plurality of requests that are received by the RAUs 403₀-403₁₅ and accumulated by the MAUs within the MAAs 404₀-404₁₅. FIGS. 2 and 3 depict example details of an IDP, an RAU, an MAU and an MAA. The data that is stored in a memory is input to a corresponding IDP, and processed into each of the 16 MAAs. It should be understood that although the memories 401₀-401₇ are depicted as being separate, the memories 401₀-401₇ may be any combination of separate memories or unified memories.

The various functional blocks depicted in FIGS. 2-4 may be embodied as modules formed from any combination of software, firmware and/or hardware that is configured to provide the functionality described in connection with the functional block. That is, the modules that may embody the functional blocks of FIGS. 2-4 may collectively or individually, be embodied as software, firmware and/or hardware that forms part of a larger system, such as, but not limited to, an IC, an SoC and so forth.

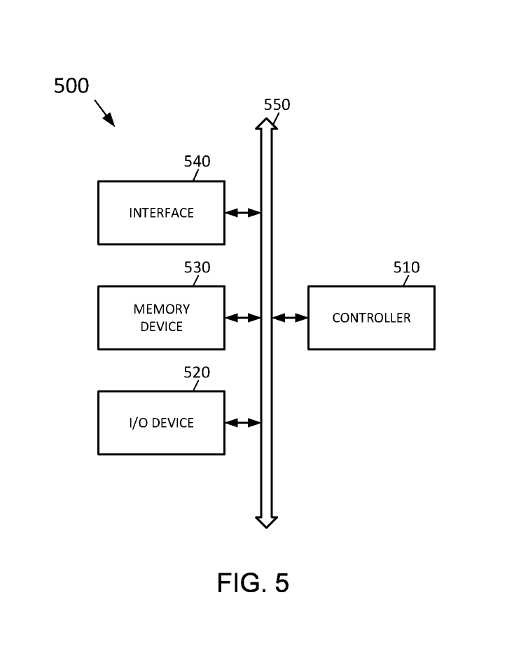

FIG. 5 depicts an electronic device 500 that includes one or more integrated circuits (chips) forming a system that efficiently skips 0-value weights in parallel in a Winograd-based implementation of convolutions according to the subject matter disclosed herein. Electronic device 500 may be used in, but not limited to, a computing device, a personal digital assistant (PDA), a laptop computer, a mobile computer, a web tablet, a wireless phone, a cell phone, a smart phone, a digital music player, or a wireline or wireless electronic device. The electronic device 500 may include a controller 510, an input/output device 520 such as, but not limited to, a keypad, a keyboard, a display, a touch-screen display, a camera, and/or an image sensor, a memory 530, and an interface 540 that are coupled to each other through a bus 550. The controller 510 may include, for example, at least one microprocessor, at least one digital signal process, at least one microcontroller, or the like. The memory 530 may be configured to store a command code to be used by the controller 510 or a user data. Electronic device 500 and the various system components of electronic device 500 may form a system that efficiently skips 0-value weights in parallel in a Winograd-based implementation of convolutions according to the subject matter disclosed herein. The interface 540 may be configured to include a wireless interface that is configured to transmit data to or receive data from a wireless communication network using a RF signal. The wireless interface 540 may include, for example, an antenna, a wireless transceiver and so on. The electronic system 500 also may be used in a communication interface protocol of a communication system, such as, but not limited to, Code Division Multiple Access (CDMA), Global System for Mobile Communications (GSM), North American Digital Communications (NADC), Extended Time Division Multiple Access (E-TDMA), Wideband CDMA (WCDMA), CDMA2000, Wi-Fi, Municipal Wi-Fi (Muni Wi-Fi), Bluetooth, Digital Enhanced Cordless Telecommunications (DECT), Wireless Universal Serial Bus (Wireless USB), Fast low-latency access with seamless handoff Orthogonal Frequency Division Multiplexing (Flash-OFDM), IEEE 802.20, General Packet Radio Service (GPRS), iBurst, Wireless Broadband (WiBro), WiMAX, WiMAX-Advanced, Universal Mobile Telecommunication Service—Time Division Duplex (UMTS-TDD), High Speed Packet Access (HSPA), Evolution Data Optimized (EVDO), Long Term Evolution-Advanced (LTE-Advanced), Multichannel Multipoint Distribution Service (MMDS), and so forth.

As will be recognized by those skilled in the art, the innovative concepts described herein can be modified and varied over a wide range of applications. Accordingly, the scope of claimed subject matter should not be limited to any of the specific exemplary teachings discussed above, but is instead defined by the following claims.

What is claimed is:

1. A method, comprising:
transforming, by a first input data path (IDP) unit, a first input feature map to a Winograd domain, wherein the transformed first input feature map includes a first plurality of input matrices, and wherein each input matrix of the first plurality of input matrices includes a plurality of elements;
providing, by the first IDP unit, a first plurality of requests, each for a first plurality of non-zero weights of transformed weight kernels with corresponding elements to a first request assembly unit (RAU); and
generating, by a first multiply accumulate array (MAA), a first plurality of output matrices in parallel for a first output feature map based on applying the first plurality of non-zero weights to corresponding elements for each input matrix.

2. The method of claim 1, further comprising:
determining, by a position determiner within the first IDP unit, a position of at least one non-zero-value weight within the first transformed weight kernel; and
wherein providing, by the first IDP unit, the first plurality of requests further comprises providing, by the first IDP unit, the first plurality of requests, each for the first plurality of non-zero weights of transformed weight kernels with corresponding elements to the first RAU.

3. The method of claim 2, further comprising:
skipping, by the first IDP unit, a request corresponding to a zero-value weight within the first transformed weight kernel based on an indication of the zero-value weight.

4. The method of claim 1, further comprising:
transforming, by a second IDP unit, a second input feature map to the Winograd domain, wherein the transformed second input feature map includes a second plurality of input matrices, and wherein each input matrix of the second plurality of input matrices includes a plurality of elements;
providing, by the second IDP unit, a second plurality of requests, each for a second plurality of non-zero weights of transformed weight kernels with corresponding elements to the first RAU;
reordering, by the first RAU, the first plurality of requests and the second plurality of requests based on processing requests associated with elements at a common position of a respective matrix; and
generating, by the first MAA, the plurality of output matrices in parallel for the first output feature map based on the reordered requests.

5. The method of claim 4, further comprising:
providing, by the first IDP unit, a third plurality of requests, each for a third plurality of non-zero weights of transformed weight kernels with corresponding elements to a second RAU;
providing, by the second IDP unit, a fourth plurality of requests, each for a fourth plurality of non-zero weights of transformed weight kernels with corresponding elements to the second RAU;
reordering, by the second RAU, the third plurality of requests and the fourth plurality of requests based on processing the requests associated with the elements at a common position of the respective matrix; and
generating, by a second MAA, a second plurality of output matrices in parallel for a second output feature map based on the reordered requests, where the second output feature map is generated in parallel with the first output feature map.

6. The method of claim 4, further comprising:
determining, by a first position determiner within the first IDP unit, a position of at least one non-zero-value weight within the first transformed weight kernel;
determining, by a second position determiner within the second IDP unit, a position of at least one non-zero-valued weight within the second transformed weight kernel; and
wherein providing, by the first IDP unit, the first plurality of requests further comprises providing, by the first IDP unit, the first plurality of requests, each for the first plurality of non-zero weights of transformed weight kernels with corresponding elements to the RAU, and
wherein providing, by the second IDP unit, the second plurality of requests further comprises providing, by the second IDP unit, the second plurality of requests, each for the second plurality of non-zero weights of transformed weight kernels with corresponding elements to the RAU.

7. A system to generate a plurality of output feature maps from an input feature map, the system comprising:
a first input data path (IDP) to transform a first input feature map to a Winograd domain, the transformed first input feature map including a first plurality of input matrices, and each input matrix of the first plurality of input matrices including a plurality of elements, the first IDP to further generate a first plurality of requests, each for a first plurality of non-zero weights of transformed weight kernels with corresponding elements;
a request assembly unit (RAU) coupled to the first IDP to receive the first plurality of requests; and
a first multiply accumulate array (MAA) coupled to the RAU, to generate a plurality of output matrices in parallel for a first output feature map based on applying the first plurality of non-zero weights to corresponding elements for each input matrix. Patent Application Page 22 of 26 Attorney Docket No. 1535-321

8. The system of claim 7, further comprising:
a position determiner to determine a position of at least one non-zero-value weight within the first transformed weight kernel; and
wherein the first IDP unit is further to provide the first plurality of requests, each for the first plurality of non-zero weights of transformed weight kernels with corresponding elements to the RAU.

9. The system of claim 8, wherein the first IDP unit skips a request corresponding to a zero-value weight within the first transformed weight kernel based on an indication of the zero-value weight.

10. The system of claim 7, further comprising:
a second IDP unit to transform a second input feature map to the Winograd domain, the transformed second input feature map including a second plurality of input matrices, and each input matrix of the second plurality of input matrices including a plurality of elements, the second IDP to further generate a second plurality of requests, each for a second plurality of non-zero weights of transformed weight kernels with corresponding elements;
wherein the RAU is to further reorder the first plurality of requests and the second plurality of requests based on processing requests associated with elements at a common position of a respective matrix; and
wherein the first MAA is to further generate the plurality of output matrices in parallel for the first output feature map based on the reordered requests.

11. The system of claim 10, wherein:
the first IDP unit provides a third plurality of requests, each for a third plurality of non-zero weights of transformed weight kernels with corresponding elements to a second RAU;
the second IDP unit provides a fourth plurality of requests, each for a fourth plurality of non-zero weights of transformed weight kernels with corresponding elements to the second RAU;
the second RAU reorders the third plurality of requests and the fourth plurality of requests based on processing the requests associated with the elements at a common position of the respective matrix; and
a second MAA generates a second plurality of output matrices in parallel for a second output feature map based on the reordered requests, where the second output feature map is generated in parallel with the first output feature map.

12. The system of claim 10, further comprising:
a first position determiner to determine a position of at least one non-zero-value weight within the first transformed weight kernel; and
a second position determiner to determine a position of at least one non-zero-valued weight within the second transformed weight kernel,
wherein the first IDP unit is to further provide the first plurality of requests, each for the first plurality of non-zero weights of transformed weight kernels with corresponding elements to the RAU, and
wherein the second IDP unit is to further provide the second plurality of requests, each for the second plurality of non-zero weights of transformed weight kernels with corresponding elements to the RAU.

13. The system of claim 12, wherein the first IDP unit skips a request corresponding to a zero-value weight within the first transformed weight kernel based on an indication of the zero-value weight.

14. The system of claim 12, wherein the second IDP unit skips a request corresponding to a zero-value weight within the second transformed weight kernel based on an indication of the zero value weight.

15. The system of claim 7, further comprising a memory storing the first input feature map, the first IDP receiving the stored first input feature map from the memory.
